(19) United States
(12) Patent Application Publication
(10) Pub. No.: US 2009/0223129 A1
(43) Pub. Date: Sep. 10, 2009

(54) METHOD AND DEVICE FOR DETERMINING A GAS LEAK

(75) Inventors: Hugues De Radigues, Rhode St. Genese (BE); Paul Andre, Soignies (BE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: CLEVERGAZ SPRL, BRUSSELS (BE)

(21) Appl. No.: 12/280,334

(22) PCT Filed: Feb. 22, 2006
(86) PCT No.: PCT/BE2007/000018

§ 371 Date: Dec. 11, 2008

(30) Foreign Application Priority Data
Feb. 22, 2006 (BE) 2006/0115
Dec. 8, 2006 (BE) 2006/0607

(51) Int. Cl. F17D 5/02

(52) U.S. Cl. 48/194; 48/193

(57) ABSTRACT

Apparatus and method for detecting a gas leak in a gas distribution system or part thereof, and comprising:
(a) a gas inlet connected to a gas-consuming peripheral (10);
(b) a means (50) of detecting gas flow rate, which is situated downstream of and close to said inlet;
(c) a variable-volume buffer chamber (11), coupled to said distribution system downstream of the detection means (50);
(d) a valve (6) controlled by a control means (6A) for leaving or not leaving the gas free to pass from the gas source or supply to the buffer chamber (11) according to the amount of gas present therein; and
(e) a means (8) capable of emitting a leak signal when the detection means (50) detects a gas flow rate higher than a predetermined value when the control means (6A) is interrupting the supply of gas to the buffer chamber (11).

### FIELD OF THE INVENTION

The subject of the present invention is a method and a device capable of determining a leak in a distribution system or part thereof.

### TECHNOLOGICAL BACKGROUND

Belgian patent BE09600615 discloses a method of monitoring a fluid flow. The method according to that document is as follows:
the flow rate of the flow is measured at a given first moment,
if this first measurement is above a chosen value, the first measurement is stored in memory and a second measurement of the flow is taken at a second moment,
the first and second measurements are compared and if the difference between said measurements is above a determined value, the monitoring process is repeated, whereas if the difference is below a tolerance, a leak signal is generated or the arrival of fluid is interrupted.

A method such as this is suitable for monitoring the flow of liquid. The monitoring device according to that Belgian patent BE09600615 has no buffer chamber capable of containing a variable amount of fluid. A device such as this is therefore unable to determine a gas leak, because it is not possible to determine zero or substantially zero gas flow rates at frequent intervals. Specifically, if there is a gas leak, then the leak needs to be detected quickly which means that it is often impossible to wait for two substantially identical flow rates to be measured at individual moments in time.

Another method is known for monitoring the presence of one or more leaks in a distribution installation in which consumer outlets or appliances are fitted (taps, showers, baths, etc. in the case of water, gas heaters, convectors, cookers, etc. in the case of gas); in that method, any consumption by consumer outlets or appliances is shut off (for example taps in the closed position) for a determined period, for example 24 hours, and the amount or loss of fluid flowing through the distribution installation over this period of time is measured using the water or gas meter. If an amount of gas or water has flowed through the installation (normally without any useful consumption), then this indicates that there is a leak. In the case of gas, a method such as this is unsuitable because, if there is a leak, there is the risk of a significant build-up of gas in a particular location, giving rise to a substantial risk of an explosion or accident.

The present invention is aimed at a method allowing rapid detection of a gas leak in a distribution system or part thereof, which method is advantageously automatic.

### SUMMARY OF THE INVENTION

The present invention is defined in the independent claims that follow. Preferred alternative forms of embodiment are defined in the dependent claims. One subject of the invention is a method for determining a gas leak in a distribution system or part thereof, and/or for checking for normal or abnormal operation in a distribution system or part thereof, said system or portion being connected to a gas source or supply, in which method the flow rate of gas flowing from the gas source to said distribution system or part thereof is detected. Said method is characterized in that the distribution system or part thereof, particularly one or more peripherals mounted on the distribution system and capable of consuming gas, is associated with a dynamic bank or device comprising at least one buffer chamber and at least one control means capable of interrupting the supply of gas to the device when the buffer chamber is filled with an amount of gas greater than or equal to a predetermined first amount, and in that the gas flow rate from the source or the absence of such a flow rate is determined at least when the control means is interrupting the supply of gas to the device.

The device with its buffer chamber or chambers is a kind of dynamic bank designed to introduce, artificially, variations into the flow rate of gas supplied to the device, while at the same time ensuring that one or more peripherals consumes gas in the normal way. This dynamic bank is successively charged with and discharges gas as gas is consumed in one or more peripherals mounted downstream of the dynamic bank. When this bank is in use, it commands the shutting-off of the valve 6. The valve 6 is in the open position as soon as the amount of gas present in the bank drops below a predetermined amount. This bank is quickly recharged thanks to the significant excess of gas pressure in the pipe upstream, by comparison with the specific requirement of each consumer appliance or peripheral. While the flow of gas is being interrupted by the control valve, a flow meter or detector mounted upstream of the device will be able to determine that there is a leak between the meter or detector and the dynamic bank or device. While the bank is being recharged, the meter or detector will determine either a constant flow rate over a short period of time or a significant variation in flow rate over a short period of time, this short period of time advantageously being, for example, 1 to 10 seconds.

In the case of a distribution system capable of supplying gas to several peripherals, the main meter will detect one or more different bank recharges, and this will have the effect of varying the flow rate and therefore of revealing a flow rate that is not constant during the recharging period.

Advantageously the method is a method in which, in the absence of a zero or substantially zero flow rate over a first determined period of time and/or if there is a non-zero flow rate over a second determined period of time, a leak or potential leak or abnormal consumption signal is emitted. According to one embodiment, at least when the control means is interrupting the supply of gas to the device, in the absence of a zero or substantially zero flow rate over a first determined period of time and/or in the event of a non-zero flow rate over a second determined period of time and/or in the event of an absence in variation in flow rate below a determined permissible variation, advantageously a variation of less than 5% by volume, preferably less than 10% by volume, preferably less than 15% by volume over a third determined period of time, a leak or potential leak or abnormal consumption signal is emitted, said signal advantageously being used to interrupt the supply of gas to at least part of the circuit located upstream of the dynamic bank or device and/or to interrupt a main supply of gas to the distribution circuit. The gas will, however, advantageously be interrupted tolerating a certain level of leakage, for example a leakage level of 12 l/h or less, preferably a leakage level of 6 l/h or less.

According to another possible alternative form of embodiment of the method according to the invention, the gas leak signal or signals of a distribution system comprising several peripherals or of several peripheral circuits or peripherals of one and the same distribution system is or are determined as a function of time. When the number of leak signals exceeds a predetermined value over a determined period of time, a signal is emitted for example to shut off the main gas supply and/or the gas supply to an installation control member. The evolution in the level of leaks can thus be monitored, thus allowing those responsible for the gas to determine whether an installation is still compliant from a leakage standpoint.

According to an alternative form of embodiment, the method is a method in which when a zero or substantially zero flow rate is determined over a first determined period of time (for example of 1 to 25 seconds), a “no leak” or “consumption normal” signal is emitted.

According to a particular alternative form, at least when the control means is interrupting the supply of gas to the device, in the event that a zero or substantially zero flow rate is determined over a first determined period of time and/or in the event that a variation in flow rate greater than a determined minimum variation in flow rate, advantageously a variation of at least 5% by volume, preferably at least 10% by volume, particularly at least 25% by volume is determined during a third period of time. Advantageously, the means interrupting the supply of gas is made to move between at least a first position in which said control means allows gas to pass from the gas supply to the device or bank in order at least to fill the buffer chamber, when the amount of gas in the buffer chamber is below or equal to a second determined amount, and a second position in which said control means interrupts the supply of gas to the device when the amount of gas in the buffer chamber is above or equal to said first determined amount.

As a preference, use is made of a buffer chamber capable of containing an amount of gas corresponding at least to the average amount of gas used over a period of time corresponding at least to once and preferably at least to twice the time needed, with no gas consumed in said distribution system or part thereof downstream of the device, to fill the buffer chamber with an amount of gas equal to or greater than said first predetermined amount. For example, the time needed to fill the buffer chamber is under 30 seconds, whereas the buffer chamber is capable of containing an amount of gas corresponding to at least 30 seconds of normal consumption, in particular at least one minute of normal consumption. The buffer chamber is therefore used to allow the flow of gas to the device to be interrupted for periods of time while at the same time providing a normal consumption of gas via the distribution system. The periods for which flow is interrupted are separated from one another by a period during which the buffer chamber is filled.

It is evident that the buffer chamber may comprise several buffer sub-chambers.

According to one embodiment, use is made of a variable-volume buffer chamber. For example, the volume of the chamber may vary between a minimum volume and a maximum volume. According to an advantageous detail, use is made of a buffer chamber positioned in parallel with a pipe associated with the distribution system or part thereof or peripheral, this advantageously being positioned downstream of the distribution system, particularly upstream of the peripheral or part thereof, for example in parallel with a pipe of the peripheral.

According to another advantageous feature, the buffer chamber is designed to contain an amount of gas corresponding to a consumption, advantageously to a normal average consumption, over a determined period of time. The supply of gas is interrupted by the control device if, at least for a moment during this period of time, a zero or substantially zero flow of gas to the device is not detected and/or if a constant flow of gas is detected during this period of time or part of this period.

When leaks are being detected in more than three peripherals or more than three peripheral networks of one and the same distribution system for which the consumption flow rate is determined, each peripheral or peripheral network comprising its own buffer chamber, it is advantageous for the buffer chambers to have different maximum volumes. For example, in the case of three peripherals, the maximum capacity of one buffer chamber will, for example, be at least twice the capacity of another buffer chamber or at least equal to the sum of the maximum capacities of two other buffer chambers.

Another subject of the invention is a dynamic bank or device capable of creating variations in gas flow rate that can be used to determine a gas leak in a distribution system or part thereof, for example to one or more peripherals or to determine normal or abnormal operation of a distribution system or part thereof, said system or portion being connected to a gas source or supply, said dynamic bank or device being designed to be mounted upstream of a distribution system or part of such a system or to be associated with one or more peripherals capable of consuming gas. The bank or device comprises a coupling means designed to form a coupling with a means of detecting a flow or lack of flow of gas flowing from the gas source to said distribution system or part thereof, said detection means being associated with a means capable of emitting a leak or potential leak or no-leak signal. Said bank or device further comprises at least one buffer chamber capable of receiving gas from the distribution system or from part thereof and a control means capable of interrupting the supply of gas to the bank or device when the buffer chamber is filled with an amount of gas greater than or equal to a first predetermined amount, the detection means being designed to determine the presence or absence of a gas flow from the supply or source that supplies said device.

The coupling between the dynamic bank or device and the means of detecting a flow or a lack of flow may be via a wave, for example a radio wave, via an electric signal, etc.

Advantageously, the device is associated with a flow detection means,
in which the means associated with the detection means able to emit a leak or potential leak or abnormal consumption signal at least when the control means is interrupting the supply of gas to the device, in the event of an absence of zero or substantially zero flow rate during a first determined period of time and/or in the event of a non-zero flow rate during a second determined period of time and/or in the event of a variation in flow rate below a determined permissible variation advantageously of less than 5% by volume, preferably less than 10% by volume, preferably less than 15% by volume during a third determined period, and/or
in which the means associated with the detection means is designed to emit a no leak or consumption normal signal at least when the control means is interrupting the supply of gas to the device, in the event that a zero or substantially zero flow rate is determined during a first determined period of time and/or in the event that a variation in flow rate higher than a determined minimum variation in flow rate, advantageously of at least 5% by volume, preferably of at least 10% by volume, particularly of at least 25% by volume is determined during a third period of time.

Advantageously the control means is designed to command the means that interrupt the supply of gas to move between at least a first position that allows gas to pass from the gas supply or source to the device in order at least to fill the buffer chamber, when the amount of gas in the buffer chamber is less than or equal to a second determined amount, and a second position in which the supply of gas to the device is interrupted when the amount of gas in the buffer chamber is greater than or equal to said first determined amount.

As a preference, the control means comprises at least one sensor designed to determine or to estimate the amount of gas present in the buffer chamber, and in that the control means is designed to command the means that interrupts the supply of gas to move between at least a first position that allows gas to pass from the gas supply or source to the device in order at least to fill the buffer chamber, when a or the sensor determines an amount of gas in the buffer chamber that is less than a second determined amount, and a second position for which the supply of gas to the device is interrupted when a or the sensor determines an amount of gas in the buffer chamber that is higher than or equal to said first determined amount.

According to one particular feature of one embodiment of the device according to the invention, the buffer chamber is capable of containing an amount of gas corresponding at least to the average amount of gas used via the distribution system or part thereof over a period of time corresponding at least to once and advantageously at least to twice the time needed, with no gas consumed in said distribution system or part thereof downstream of the device, to fill the buffer chamber with an amount of gas equal to or greater than the first determined amount.

According to one detail of an advantageous embodiment, the buffer chamber is a variable-volume chamber.

As a preference, the device comprises a first sensor designed to determine a position of the chamber corresponding to a volume lower than a determined minimum volume and a second sensor designed to determine a position of the chamber corresponding to a determined maximum volume.

According to one embodiment detail, the buffer chamber is placed in parallel with a pipe designed to connect the distribution system or part thereof to the gas source or supply.

According to another advantageous detail, the buffer chamber is designed to contain an amount of gas that corresponds to a consumption, advantageously a normal average consumption, over a determined period of time, for example over a period of under 5 minutes, particularly under 2 minutes, preferably under 1 minute, for example of 5 seconds to about 1 minute, particularly of under 15 seconds. This makes it possible to carry out an almost instant check on the absence of leaks.

According to another advantageous particular feature, at least one means acts on the buffer chamber in order to exert a force that opposes the filling of the buffer chamber.

According to yet another advantageous particular feature, the buffer chamber is associated with a valve controlling the filling of the buffer chamber, said valve advantageously being a non-return valve, and with another valve controlling the discharge of gas from the buffer chamber. According to yet another form of embodiment, the device comprises an enclosed space in which there moves a membrane that defines one wall of the buffer chamber. The enclosed space is thus divided into a first part capable of at least partially defining a volume of the buffer chamber, and a second part in which the return means advantageously lies. The second part is associated with one or more means for controlling the gas pressure in this second part. Such means are, for example:
one or more holes, which are advantageously associated with one or more means of closing them off in the event of a fire or in the event of a temperature higher than a determined temperature, for example intumescent flanges, safety valves, etc.,
a secondary enclosed space in communication with the second part by means of passages, advantageously associated with one or more means of closing them off in the event of a fire or in the event of a temperature higher than a determined temperature, for example intumescent flanges, safety valves, etc., in which space there is positioned a supple and flexible (advantageously substantially inelastic) membrane. The supple and flexible membrane is made of a fire-retardant and fire-resistant material, for example one which has fire resistance FI, and is able to move in the secondary enclosed space according to the air or gas from the second part that has entered the second enclosed space. The second enclosed space has one or more holes, advantageously associated with one or more means of closing them off in the event of a fire or in the event of a temperature above a determined temperature, for example intumescent flanges, safety valves, etc., to a allow outside air to pass into and out of the second enclosed space according to the movement of the fire-resistant supple and flexible membrane.

Another subject of the invention is a dynamic bank or device capable of creating variations in gas flow rate that can be used to determine whether there is a gas leak in a distribution system or part thereof, for example toward one or more peripherals or to determine whether a distribution system or part thereof is operating normally or abnormally, said system or portion being connected to a gas source or supply, said dynamic bank or device being designed to be mounted downstream of a distribution system or part of such a system or to be associated with one or more peripherals, the bank or device comprising at least one buffer chamber, a means capable of interrupting the supply of gas to the bank or device when the buffer chamber is filled with an amount of gas greater than or equal to a first predetermined amount, and a means of pressurizing the gas present in the buffer chamber, said means of pressurizing the gas in the buffer chamber being a system comprising at least one element chosen from one or more compressors, a means acting on at least one moving wall of the buffer chamber, and a combination thereof.

Advantageously, the buffer chamber of this dynamic bank or device has a volume that can vary between a minimum volume and a maximum volume, whereas a mechanical means acts at least on a moving wall (advantageously a supple membrane) of the buffer chamber in order to reduce the variable volume of the buffer chamber. The mechanical means is, for example, one or more springs (with the same spring rate or the same return force or different return forces), or a component collaborating with a spring (for example a sheet or a plate secured to the membrane and on which a spring acts, possibly with the interposition of an intermediate component such as a lever arm, a cam, etc. for example).

According to one embodiment, the buffer chamber comprises at least one moving wall on which there acts at least the force of gravity of a component capable of bringing about a reduction in the variable volume of the buffer chamber. In this embodiment, it is necessary for the movement of the moving wall to be at least partially in the vertical direction.

According to a detail of another embodiment, the buffer chamber comprises at least one moving wall and at least one supply of gas taken not from the gas distribution system that fills the buffer chamber or a supply of liquid and designed to effect a reduction in the variable volume of the buffer chamber. The gas that does not come from the distribution system may advantageously be a supply that can be coupled to a compressed-air source or to an air compressor or to a source of a liquid, for example from a chamber in which a piston moves.

According to another detail of one embodiment, the buffer chamber comprises a moving wall, said moving wall having one face facing toward the buffer chamber and an opposite face facing toward a control chamber, whereas the bank or device comprises a means of pressurizing the control chamber. In particular, the means of pressurizing the control chamber is a means that supplies a liquid or a gas to the control chamber.

According to one particular feature, the device comprises at least one system with at least one spring or some other return element acting directly, or with the interposition of some other component, on a moving wall of the buffer chamber.

According to another particular feature, the device comprises at least one compressor for supplying to the buffer chamber gas in a form that is compressed by comparison with the gas that flows through the bank or device.

According to yet another particular feature of some embodiments, the device comprises: a moving wall for the buffer chamber and at least one means for supplying the buffer chamber with gas in a form that is compressed by comparison with the pressure of the gas that flows through the device, and/or—a regulator for controlling the pressure leaving the bank or device.

According to yet another embodiment, the device comprises an enclosed space in which there moves a membrane that defines one wall of the buffer chamber. The enclosed space is thus divided into a first part capable at least partially of defining a volume of the buffer chamber and a second part in which the return means advantageously lies. The second part is associated with one or more means for controlling the gas pressure in this second part.

Such means are, for example: one or more holes, advantageously associated with one or more means of closing them off in the event of a fire or in the event of a temperature higher than a determined temperature, for example intumescent flanges, safety valves, etc.—a secondary enclosed space in communication with the second part by means of passages, which are advantageously associated with one or more means of closing them off in the event of a fire or in the event of a temperature above a determined temperature, for example intumescent flanges, safety valves, etc., in which enclosed space there lies a supple and flexible (advantageously substantially inelastic) membrane. The supple and flexible membrane is made of a fire-retardant and fire-resistant material, for example one that has a fire resistance FI, and is capable of moving in the secondary enclosed space according to the air or gas of the second part that has entered the second enclosed space. The second enclosed space has one or more holes, which are advantageously associated with one or more means of closing them off in the event of a fire or in the event of a temperature above a determined temperature, for example intumescent flanges, safety valves, etc., to allow external air to pass into and out of the second enclosed space according to the movement of the fire-resistant supple and flexible membrane.

A further subject of the invention is a gas distribution system with advantageously one or more peripherals, said system and/or one or more peripherals being associated with a dynamic bank or device according to the invention. The distribution system advantageously further comprises a flow detector or a flow meter capable of determining at least variations in flow rate practically continuously. Another subject of the invention is a distribution system comprising a series of pipes each intended to supply gas to one or more peripherals capable of consuming gas, in which system at least two pipes or two peripherals are each associated with a dynamic bank or device according to the invention.

Another subject of the invention is the use of a device according to the invention in an existing installation, to seek out any leaks or to confirm whether operation is normal or abnormal. In this use, a device according to the invention is mounted on the gas circuit or part of the gas circuit that is to be checked. After the check, the device is removed to test another circuit. In this use, a method according to the invention is advantageously employed.

Finally, yet another subject of the invention is a peripheral intended to consume gas, said peripheral comprising a supply pipe associated with a dynamic bank or device according to the invention.

Specifics and details of the invention will become apparent from the following detailed description of a preferred form of embodiment in which reference is made to the drawings attached hereto.

### DESCRIPTION OF THE FIGURES

In these figures

FIG. 1 is a schematic view of a gas distribution installation equipped with a device according to the invention, the buffer chamber having its minimum volume,

FIG. 2 is a view of the installation of FIG. 1 with the buffer chamber having its maximum volume,

FIG. 3 is a schematic view of another installation according to the invention,

FIG. 4 is a schematic view of another gas distribution installation equipped with a device according to the invention, the buffer chamber having its minimum volume,

FIG. 5 is a view of the installation of FIG. 4 with the buffer chamber having its maximum volume,

FIGS. 6 and 7 are schematic views of another dynamic bank,

FIGS. 8 to 12 are further views still of dynamic banks according to the invention, and

FIG. 13 is a view of a device similar to that of FIG. 4.

### DETAILED DESCRIPTION OF THE INVENTION

The distribution unit 1 comprises one or more pipes 2 intended to supply gas to various gas-consuming appliances or peripherals 10 such as water heaters, heating appliances, etc., these peripherals advantageously being adjacent and close to the dynamic bank or device 4.

Between the gas inlet and the peripherals 10 there is a distribution installation 3 (for example for distributing gas to a house or an apartment). A dynamic bank or device 4 capable of creating variations in gas flow rate that can be used to determine a gas leak in a distribution system or part thereof is positioned upstream of the pipe 2 and of the peripherals 10, but downstream of the pipe 3. The gas inlet 5 is equipped with a manually operated shut-off valve 5 (for example a valve on the usage meter, for example with a device or system for detecting constant flow) but also with automatic control.

An automatic shut-off valve 6 or safety valve, said valve advantageously also being manually operated, is, for its part, mounted upstream of the peripherals, for example at the end of the pipe 3. The shut-off valve comprises a control unit 6A.

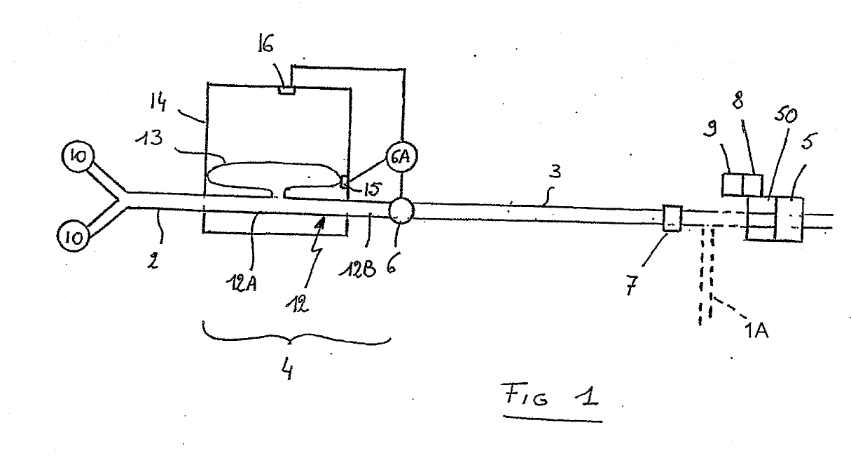

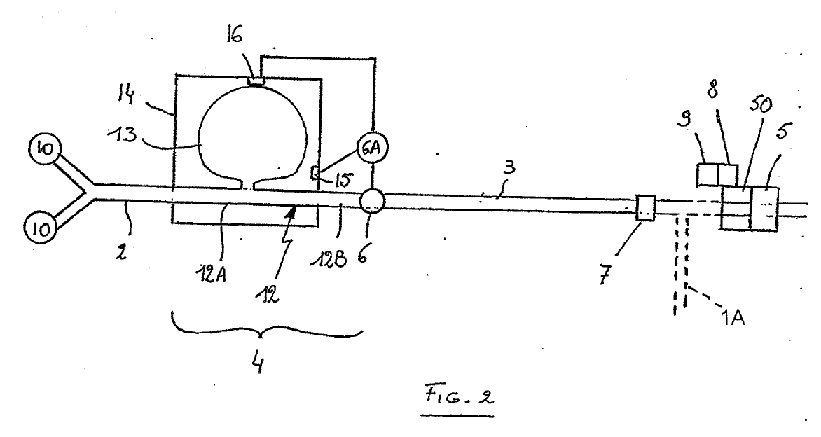

The dynamic bank or device 4 mounted between the shut-off valve 5 and the peripherals 10 after the distribution circuit 3 comprises
a means 50 of detecting or measuring the flow rate of gas flowing from the gas source 5 to said distribution system 3, this means detecting or measuring a flow rate in the pipe 3 upstream of the automatic valve 6,
a means 8 associated with said gas flow detection means 50 and which is capable of emitting a leak or potential leak signal in the absence of a zero or substantially zero flow rate or of variations in flow rate greater than a determined value for a first determined period of time and/or in the event of a non-zero flow rate during a second determined period of time of emitting a leak or potential leak signal. This means 8 is advantageously designed to quickly determine substantial constant flow rates over a certain period of time so as quickly to detect significant losses of gas,
a means 9, such as electric leads, for transferring a leak signal in order to operate the valve 5 so as to bring this valve into the closed position in the event of a leak and possibly (but advantageously the valve 6 or intermediate valves (7 at the inlet of a pipe of a branch), and
a buffer chamber 11 mounted in parallel on a pipe 12 connecting the valve 6 to the distribution unit 1 and the peripherals. This buffer chamber 11 has a volume that can vary between a minimum volume shown in FIG. 1 and a maximum volume shown in FIG. 2. The buffer chamber is, for example, produced in the form of a bladder 13 capable of inflating or deflating in an enclosed space 14. The enclosed space 14 advantageously comprises a portion 12A of the pipe 12 and advantageously comprises quick fit or coupling means for coupling it to the distribution unit and possibly to another portion of the pipe 12B or to the end of the pipe 3. The enclosed space 14 comprises a sensor 15, 16 for determining the position of the bladder at its minimum volume and the position at its maximum volume. The enclosed space 14 comprises one or more valves for letting gas out of the enclosed space as the bladder inflates and toward the enclosed space as the bladder deflates. This valve or these valves is or are advantageously fitted with a system for locking them in the closed position as soon as the temperature around the valve reaches a temperature higher than a predetermined temperature, for example as soon as a temperature in excess of 100° C. is determined. In one possible embodiment, the valve is in the open position to allow air to pass out of or into the enclosed space as long as the temperature outside the enclosed space is below a determined temperature value, and is in a closed position (advantageously closed automatically) as soon as the temperature outside the enclosed space exceeds the determined temperature value.

The sensors 15 and 16 send signals to the control device 6A that controls the valve 6. When the sensor 15 receives an impulse from the bladder that corresponds to the bladder 13 being in the deflated state, the sensor sends a signal to the control device 6A to open the valve 6. and allow gas from the source 3 to enter the device 4 and the distribution network or circuit 2. The gas entering the device 4 is used partly to fill the bladder 13. The bladder thus inflates to reach its maximum-volume position. At this instant, the sensor 16 sends a signal to the control device that controls the valve 6 causing it to close this valve.

The appliances 10 are therefore supplied with gas by virtue of the gas present in the bladder 13. To make it easier for the gas in the bladder to be discharged into the distribution unit 1 when the valve 6 is closed, a means may be provided in the enclosed space for returning the bladder to its minimum-volume position. Such a means may be a spring or a pressurized gas lying inside the enclosed space outside of the bladder 13.

When the valve 6 is closed, the flow measurement means 50 determines a zero flow rate or a variation in flow rate over a period of time. The control unit 6A that controls the valve 6 is therefore designed to send a signal to the measurement means 50 or to the means 8.

If the period of time for which the flow rate is zero exceeds a determined minimum period of time (for example a period of time corresponding to at least 0.5 times the time needed to fill the bladder 13) or if a variation in flow rate greater than a determined value (for example a percentage or a multiple of the normal consumption by the peripherals) is detected in a determined period of time, the measurement means 50 determines that there is no leak, whereas when the period of time for which there is zero flow rate is shorter than said determined period of time or if said minimum variation in flow rate is not detected in a determined period of time, the means 50 sends a leak signal to the control device to cause the valve 5, and possibly the valve 7, to close. A luminous signal or a radio signal is advantageously emitted to signal a leak or a potential leak.

Although the flow measurement device 50 advantageously receives only one item of information regarding whether or not the valve 6 is closed via the pipe 3 and the way in which the gas behaves in this pipe 3, it may be useful and advantageous in more complex systems to provide for the transmission of information between the control unit 6A and the control unit 8.

Likewise, in the absence of a zero flow rate over a determined maximum period of time (for example, a period of time corresponding to more than twice the time needed to fill the bladder 13, particularly more than three times the time needed to fill the bladder 13) or in the absence of closure of the valve 6 for a determined period of time, the device 6A determines that there is a leak or a potential leak or a problem with consumption at the peripherals. The control means 6A then sends a signal to command the closing of the valve 6 and/or a closure signal to a device to control the valve 5 or the valve 7 (to shut off the passage of gas to the gas distribution installation 3 and possibly to shut off the passage of gas to a distribution installation la connected to the pipe 3 upstream of the valve 6 and of the valve 7. A luminous signal or a radio signal is advantageously emitted to signal a leak or a potential leak and/or a problem with consumption. A signal such as this is sent for example to an individual responsible for monitoring the installations, to the gas distributor, to the firefighters, to the caretaker of a building, to an emergency service, etc. A signal such as this is emitted, for example, on the device that detected a leak and/or on the control unit of the main valve and/or on the constant flow detector directly downstream of the main valve. The maximum volume of the buffer chamber or bladder is advantageously determined according to the average consumption of the appliances 10. This maximum volume should not be so great that, in the event of a leak, an excessive volume of gas from the bladder would be able to escape, and, in order to be able to check for leaks in the distribution network and/or for consumption problems with one or more appliances 10 at regular and closely spaced intervals, this volume should again not be too great.

This maximum volume ranges, for example, between 2 and 4 times the average amount of gas used during a determined period of time, for example of between 30 seconds and 5 minutes. A short period is advantageous because it shortens the time between two successive checks.

The valve 5 or 7 is advantageously a valve which, in the rest or inactive position, is in the closed position. The valve is therefore held open, for example by an electromagnet. As soon as a leak or potential leak or excessive consumption is detected, the electromagnet is no longer powered, which means that the valve automatically returns to the closed position.

A device for detecting constant flow 50 is advantageously mounted directly downstream of the main valve 5. This device is able to detect leaks in the pipe 3. Specifically, when the valve 6 is in the closed position, no gas flow should normally be determined by the device 50. If a constant or continuous flow were to be detected, such a flow would indicate that there was a leak.

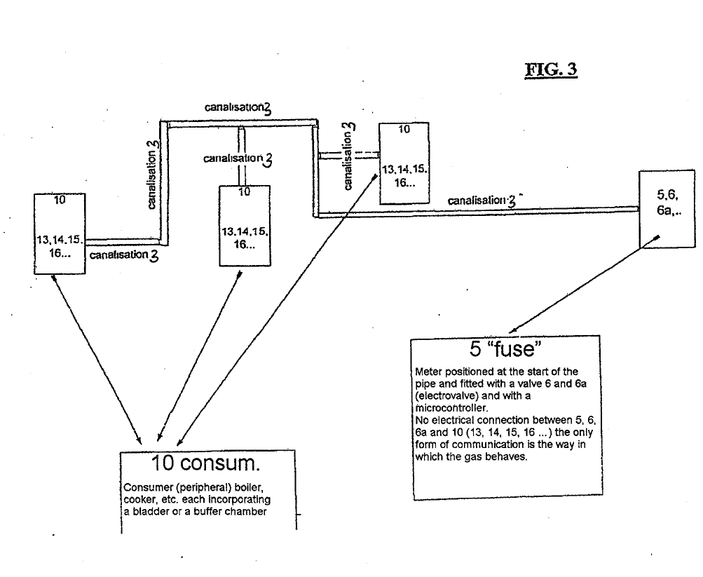

The dynamic bank is charged and discharged successively, according to the consumption of gas by one or more peripherals mounted downstream of the dynamic bank. When gas is being used from the dynamic bank or when the dynamic bank is discharging, the dynamic bank commands the closure of the valve 6. FIG. 3 is a schematic view of another installation comprising a series of peripherals 10 mounted in parallel with the pipe 3. Each peripheral is associated with a dynamic bank or device according to the invention comprising a buffer chamber 11 and capable of being charged and discharged successively according to the gas consumption.

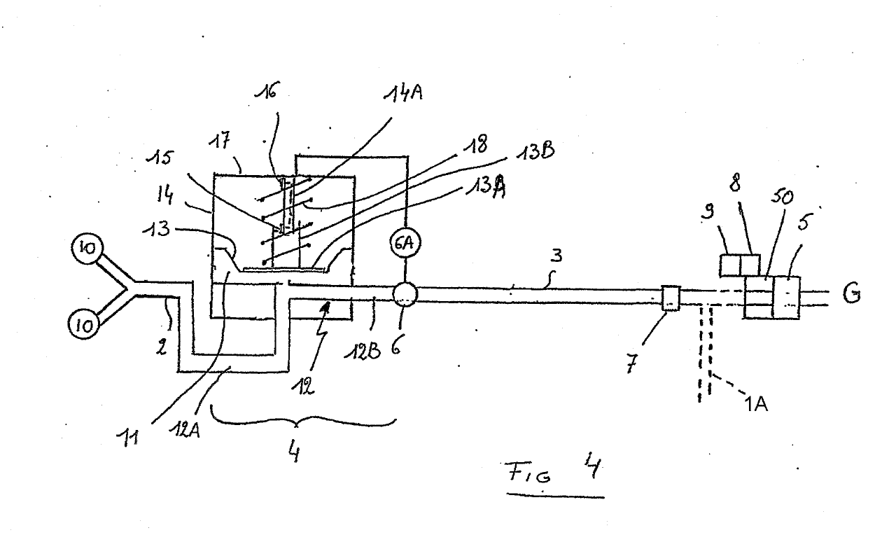

The distribution unit 1 of FIG. 4 or 5 comprises one or more pipes 2 intended to supply gas to various gas-consuming appliances or peripherals 10 such as water heaters, heating equipment, etc., these peripherals advantageously being adjacent and close to the dynamic bank or device 4.

Between the gas inlet and the peripherals 10 there is a distribution installation 3 (for example for distributing gas in a house or an apartment). A dynamic bank or device 4 capable of creating variations in gas flow rate that can be used to determine a gas leak in a distribution system or part thereof is positioned upstream of the pipe 2 and of the peripherals 10 but downstream of the pipe 3. The gas inlet G is fitted with a manually operated shut-off valve 5 (for example a valve on the usage meter, for example with a device or system for detecting constant flow), but which can also be operated automatically.

An automatic shut-off valve 6 or safety valve, said valve advantageously also being manually operated, is, for its part, mounted upstream of the peripherals, for example at the end of the pipe 3. The shut-off valve comprises a control unit 6A.

The dynamic bank or device 4 mounted between the shut-off valve 5 and the peripherals 10, after the distribution circuit 3, is associated with:
a means 50 of detecting or measuring the flow rate of gas flowing from the gas source G to said distribution system 3, this means detecting or measuring a flow in the pipe 3 upstream of the automatic valve 6,
a means 8 associated with said gas flow detection means 50 and which is capable of emitting a leak or potential leak signal in the event of an absence of zero or substantially zero flow rate or of variations in flow rate in excess of a determined value over a first determined period of time and/or in the event of a non-zero flow rate over a second determined period of time, a leak or potential leak signal. This means 8 is advantageously designed to quickly determine significant constant flow rates over a certain period of time, so that significant gas losses can be detected quickly.

A means 9, such as electric leads, for transferring a leak signal to operate the valve 5 in order to bring this valve into the closed position in the event of a leak and possibly (but advantageously the valve 6 or intermediate valves (7 at the inlet of a pipe of a branch).

The device comprises a buffer chamber 11 mounted in parallel with a pipe 12 connecting the valve 6 to the distribution unit 1 and the peripherals. This buffer chamber 11 has a volume that can vary between a minimum volume shown in FIG. 4 and a maximum volume shown in FIG. 5. The buffer chamber 11 comprises a flexible membrane 13 that is impermeable to gas. The membrane 13 is associated with a component 13A that is heavy enough to generate a force that tends to push the membrane 13 downward (under the effect of gravity). The component 13A has a hollow body 13B designed to accept a rod 14A that bears against a fixed wall 17. The rod 14A is capable of moving in the hollow body 13B as the membrane 13 moves up or down. The rod 14A and the hollow body 13B form a guide member for a spring 18. The membrane 13 moves up against the weight of the plate 13A and of the spring 18, whereas when the membrane is in the raised position, the membrane is returned downward by the force of the spring 18 and the force of gravity of the plate 13A. The enclosed space 14 advantageously comprises a portion 12A of the pipe 12 and advantageously comprises quick fit or coupling means for coupling it to the distribution unit and possibly to another portion of the pipe 12B or to the end of the pipe 3. The enclosed space 14 comprises a sensor 15, 16 for determining the position of the membrane at its minimum volume and the position at its maximum volume. The sensor 15 is, for example, secured to the rod 14A and is activated by a finger of the hollow body 13B when the membrane is in the lowered position, whereas in the raised position, the finger of the hollow body 13B acts on the sensor 16. The sensors 15 and 16 send signals to the control device 6A that controls the valve 6. When the sensor 15 receives an impulse from the finger belonging to the hollow body 13A, the sensor 15 sends a signal to the control device 6A to open the valve 6 and allow the gas from the inlet 3 to enter the device 4 and the distribution network or circuit 2. The gas entering the device 4 is used partially to fill the buffer chamber 11 and move the membrane 13 up. The membrane is thus moved up, until the volume of the buffer chamber 11 is at its maximum. At this instant, the sensor 16 is activated by the finger belonging to the hollow body 13A and sends a signal to the control device 6A that controls the valve 6, in order to close the latter.

The enclosed space 14 advantageously comprises one or more valves to allow gas out of the enclosed space as the bladder inflates and toward the enclosed space as the bladder deflates. This or these valves is or are advantageously fitted with a system for locking them in the closed position as soon as the temperature around the valve reaches a temperature above a predetermined temperature, for example as soon as a temperature in excess of 100° C. is determined. In one possible embodiment, the valve is in the open position to let air out of or into the enclosed space as long as the temperature outside the enclosed space is below a determined temperature value and is in a closed position (advantageously being closed automatically) as soon as the temperature outside the enclosed space exceeds the determined temperature value.

The appliances 10 are therefore supplied with gas by virtue of the gas present in the buffer chamber 11. To make it easier for the gas in the buffer chamber 11 to leave via the pipe 2 to the peripherals 10, the spring 18 acts on the plate 13B of the membrane. The spring is advantageously rated such that in its extension phase (with respect to a compressed position), the force exerted by the spring or springs 18 is substantially constant or so that the pressure of the gas present in the buffer chamber is substantially constant, when the valve 6 is closed. The spring load of the spring or springs may either be predetermined at the factory or adjustable according to some parameter of the network, such as pressures, type of gas, etc. Likewise, the weight of the plate 13A may be modified, for example by adding weights, to increase the force of gravity on the membrane 13. When the valve 6 is closed, the flow measurement means 50 determines a zero flow rate or a variation in flow rate over a period of time. The control unit 6A controlling the valve 6 is therefore designed to send a signal to the measurement means 50 or to the means 8.

If the period of time for which the flow rate is zero exceeds a determined minimum period of time (for example a period of time corresponding to at least 0.5 times the time needed to fill the chamber 11) or if a variation in flow rate greater than a determined value (for example a percentage or a multiple of the normal consumption by the peripherals) is detected in a determined period of time, the measurement means 50 determines that there is no leak, whereas when the period of time for which the flow rate is zero is shorter than said determined period of time or if said minimum variation in flow rate is not detected in a determined period of time, the means 50 sends a leak signal to the control device to cause it to close the valve 5, and possibly 7. A luminous signal or a radio signal is advantageously emitted to indicate a leak or a potential leak.

Although the flow measurement device 50 advantageously receives just one item of information as to whether or not the valve 6 is closed via the pipe 3 and the way in which the gas in this pipe 3 behaves, it may be beneficial and advantageous in more complex systems to provide for the transmission of information between the control unit 6A and the control unit 8. Likewise, in the absence of a zero flow rate for a determined maximum period of time (for example a period of time that corresponds to more than twice the time needed to fill the buffer chamber 11 to its maximum capacity, particularly more than three times the time needed to fill the buffer chamber 11 to its maximum capacity) or in the absence of closure of the valve 6 for a determined period of time, the device 6A determines that there is a leak or a potential leak or a problem with consumption at the peripherals. The control means 6A then sends a signal commanding closure of the valve 6 and/or a closure signal to a device controlling the valve 5 or the valve 7 to shut off the passage of gas to the gas distribution installation 3 and possibly to shut off the passage of gas to a distribution installation 1a coupled to the pipe 3 upstream of the valve 6 and of the valve 7. A luminous signal or a radio signal is advantageously emitted to indicate a leak or a potential leak and/or a problem with consumption. A signal such as this is, for example, sent to an individual responsible for monitoring the installations, to the gas distributor, to the firefighters, to the caretaker of a building, to an emergency service, etc. A signal such as this is emitted for example on the device that detected a leak and/or on the control unit controlling the main valve and/or on the constant flow detector directly downstream of the main valve.

The maximum volume of the buffer chamber is advantageously determined according to the average consumption of the appliances 10. This maximum volume should not be so great that, in the event of a leak, an excessive volume of gas from the buffer chamber would be able to escape, and, in order to be able to check for leaks in the distribution network and/or for consumption problems with one or more appliances 10 at regular and closely spaced intervals, this volume should again not be too great.

This maximum volume ranges, for example, between 2 and 4 times the average amount of gas used during a determined period of time, for example of between 30 seconds and 5 minutes. A short period is advantageous because it shortens the time between two successive checks.

The valve 5 or 7 is advantageously a valve which, in the rest or inactive position, is in the closed position. The valve is therefore held open, for example by an electromagnet. As soon as a leak or potential leak or -excessive consumption is detected, the electromagnet is no longer powered, which means that the valve automatically returns to the closed position.

A device for detecting constant flow 50 is advantageously mounted directly downstream of the main valve 5. This device is able to detect leaks in the pipe 3. Specifically, when the valve 6 is in the closed position, no gas flow should normally be determined by the device 50. If a constant or continuous flow were to be detected, such a flow would indicate that there was a leak.

The dynamic bank is charged and discharged successively, according to the consumption of gas carried out by one or more peripherals mounted downstream of the dynamic bank. When gas is being used from the dynamic bank or when the dynamic bank is discharging, the dynamic bank commands the closure of the valve 6.

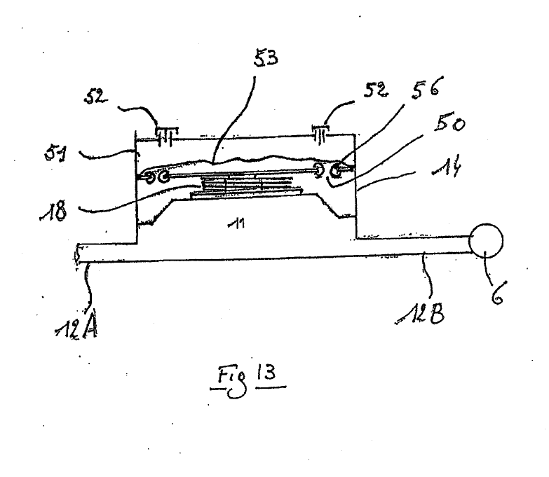

FIG. 12 is a schematic view of another installation comprising a series of peripherals 10 mounted in parallel with the pipe 3. Each peripheral is associated with a dynamic bank or device according to the invention comprising a buffer chamber 10 and capable of being charged and discharged successively according to the consumption of gas.

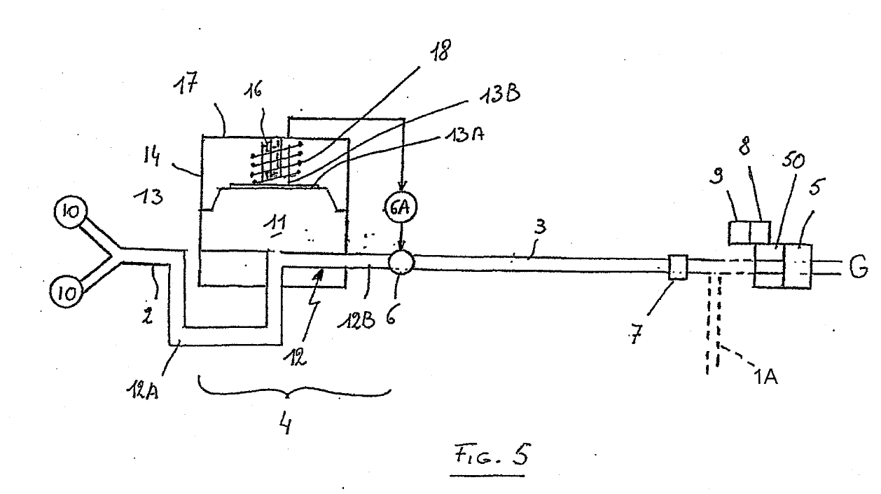

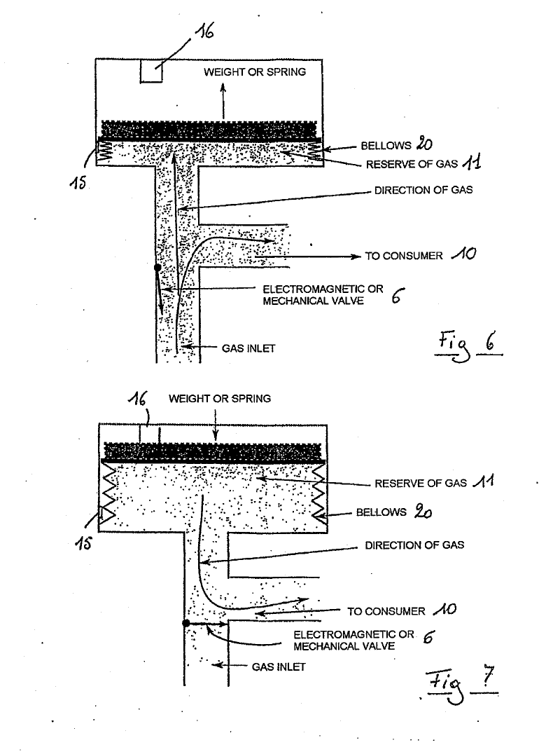

FIGS. 6 and 7 schematically show another dynamic bank according to the invention. This dynamic bank 4 comprises a bellows 20 to define a variable-volume buffer chamber 11, the upper part of the bellows being associated with a body 21 of determined weight or on which there acts a return means or spring for returning the bellows to its compressed position. The loading of the return means, for example spring or springs, may be either predetermined at the factory or adjustable according to some parameter of the network, such as pressures, type of gas, etc. Likewise, the weight of the body 21 may be altered, for example by adding weights, to increase the force of gravity on the membrane 13.

When the (electromagnetic or mechanical) valve 6 is open, the gas is able to pass to the peripherals 10 and partially into the buffer chamber 11.

When the buffer chamber is full (for example when the body 21 is acting on the sensor 16), the valve 6 is brought into the closed position, the gas from the buffer chamber 11 therefore being emptied to supply the peripherals 10. When the body 21 acts on the sensor 15, the valve 6 is brought into the open position to repeat the cycle of filling of the buffer chamber 11.

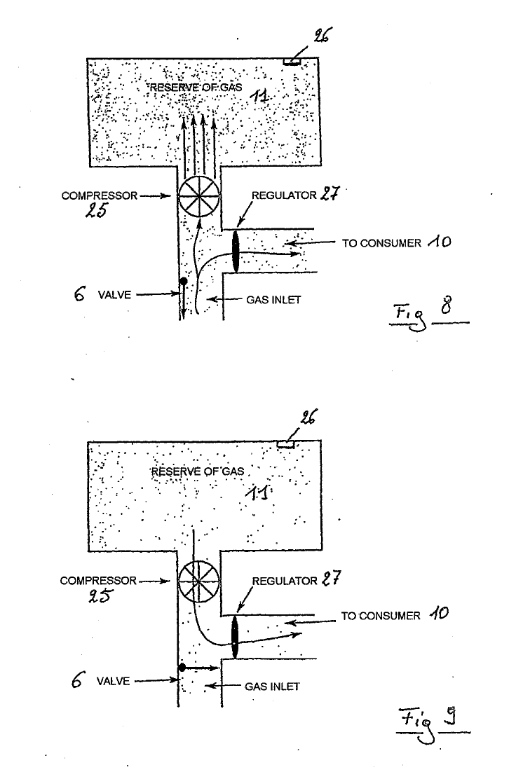

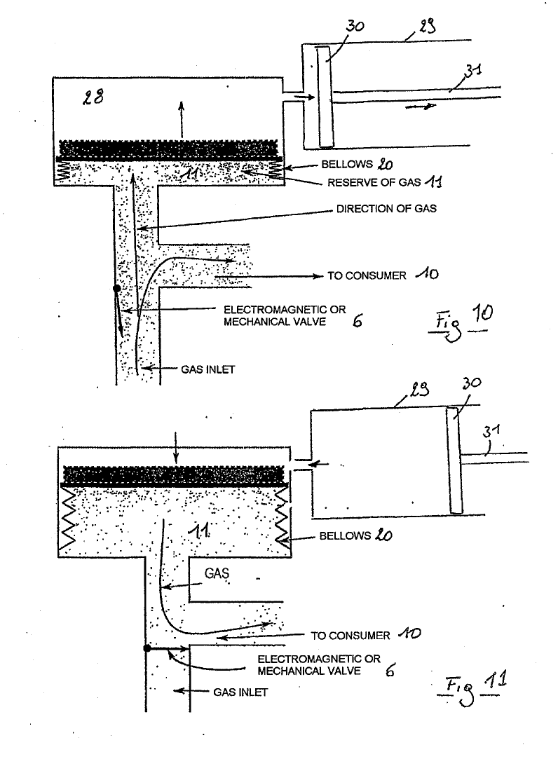

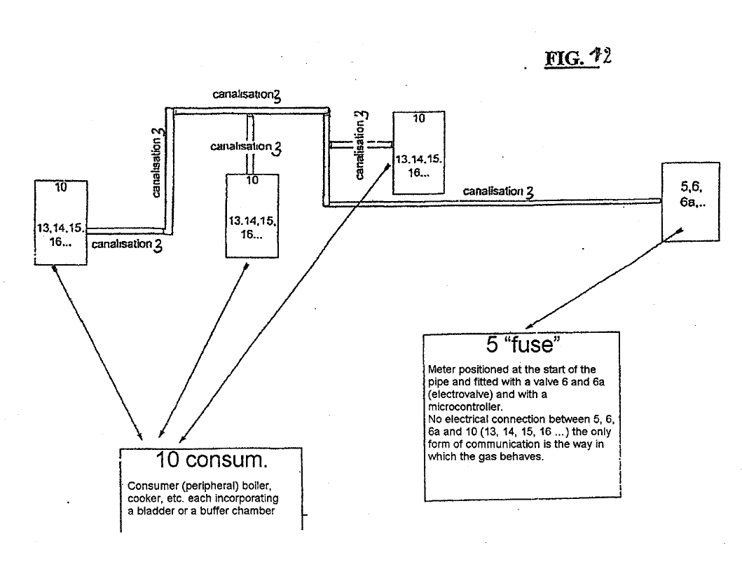

In the embodiment of FIG. 8, the buffer chamber 11 has a non-variable predetermined volume. The buffer chamber 11 is associated with a compressor 25 for storing gas under higher pressure in the buffer chamber. The pressure of the gas in the buffer chamber may thus be equal to 1.5 to 10 times the pressure of the gas supplied to the device 4. In the position of FIG. 4, some of the gas supplied to the device 4 is taken by the compressor 25 to be stored in the buffer reservoir 11. In this position, the valve 6 is in the open position. When the pressure in the reservoir reaches a determined pressure (high pressure), the pressure sensor or pressure switch 26 emits a signal to command the closing of the valve 6 and the stopping of the compressor 25. The gas present in the buffer chamber 11 then flows to the peripherals via a regulator 27 (FIG. 9). When the pressure in the buffer chamber 11 drops below a determined value, a signal is emitted to open the valve 6 and to reactivate the compressor. The cycle of filling of the buffer volume can then be repeated. In the embodiment of FIGS. 10 and 11 which is similar to the embodiment of FIGS. 6 and 7, the buffer chamber 11 is defined in an envelope 14. The envelope has a chamber 28 situated outside the buffer chamber 11. The chamber 28 is filled with a liquid and is associated with a cylinder 29 in which there moves a piston 30 the movement of which is controlled, for example, by an electric motor 31.

In the position of FIG. 10, the valve 6 is in the open position. In this position, the motor 31 is in the neutral position (allowing the piston 30 to move given the gas entering the buffer chamber 11) or in a position that causes the piston 30 to move back in order to draw liquid out of the chamber 28 toward the cylinder 29. The buffer chamber is therefore capable of accepting gas.

When the piston has reached a predetermined position, a sensor sends a signal to close the valve 6 and a signal to command the motor to move the piston 30 forward. The liquid in the cylinder is then driven into the chamber 28 to drive the gas from the buffer chamber to the peripherals 10. When the piston 30 reaches a determined position corresponding to a minimum volume of liquid in the cylinder, a sensor sends a signal to open the valve 6 and to stop the motor or to command the motor to cause the piston to move back. The cycle can then continue.

The device of FIG. 13 is similar to that of FIG. 4, except that the enclosed space 14 has one or more passages 50 to a second enclosed space 51 allowing an exchange of air with the outside via one or more holes, preferably via one or more valves 52 of some kind. A flame-retardant membrane 53, particularly one rendered flame-retardant by means of a coating, lies in the second enclosed space 51.

As the bladder or the buffer chamber 11 expands against the action of the return means 18), air from the enclosed space 14 leaves the enclosed space 14 to fill the region 55 of the enclosed space 51 that lies under the fire-retardant membrane. This fire-retardant membrane 53 is then able to expand to drive air from the second enclosed space, which air lies on the other side of the membrane 53, via the valves.

When the gas from the buffer chamber is dispatched to the network, that is to say when the volume of the buffer chamber is reduced, the air from the second enclosed space lying under the fire-retardant membrane (flexible, advantageously inelastic, membrane) 53 enters the enclosed space 14, whereas air enters the second enclosed space 51 via the valve or valves 52. A membrane such as this can thus act as a fire-safety measure.

In order further to improve fire safety, the passage or passages are advantageously fitted or associated with elements 56 (for example flanges surrounding the edges of a hole) or with layers that are intumescent or with expanding products capable of closing off the holes 50.

1. An apparatus for detecting a gas leak in a gas distribution system or part thereof, comprising:
(a) an inlet that can be coupled to a gas source or supply and connected to:
(b) at least one gas-consuming peripheral; and
(c) a means of the detecting gas flow rate, which is situated near said inlet between the inlet and the at least one peripheral;
(d) a variable-volume buffer chamber coupled to said distribution system between said detection means and the at least one peripheral, the volume of said buffer chamber being able to vary according to the flow of gas flowing through said distribution system;
(e) a valve controlled by a control means and capable:
(i) when the valve is in an open first position, of allowing gas to pass from the gas source or supply to the buffer chamber in order at least to fill the buffer chamber when the amount of gas in the buffer chamber is below or equal to a first predetermined value, and
(ii) in a closed second position, interrupting said passage of gas when the amount of gas in the buffer chamber is above or equal to a second predetermined value higher than the first predetermined value; and
(f) a means capable of emitting a leak signal when the detection means detects a gas flow rate higher than a predetermined value while the control means is interrupting the supply of gas to the buffer chamber.

2. The apparatus as claimed in claim 1, wherein the control means comprises at least one sensor designed to determine or to estimate the amount of gas present in the buffer chamber.

3. The apparatus as claimed in claim 1, wherein a means acts on the buffer chamber to exert a force that opposes the filling of the buffer chamber.

4. The apparatus as claimed in claim 1, further comprising a means of pressurizing the gas present in the buffer chamber, said means of pressurizing the gas in the buffer chamber being a system comprising at least one element chosen from one or more compressors, a means acting on at least one moving wall of the buffer chamber, and a combination thereof.

5. The apparatus as claimed in claim 4, wherein the buffer chamber has a volume that can vary between a minimum volume and a maximum volume, and wherein a mechanical means acts at least on a moving wall of the buffer chamber in order to reduce the variable volume of the buffer chamber.

6. The apparatus as claimed in claim 4, wherein the buffer chamber comprises at least one moving wall and at least one supply of gas taken not from the gas distribution system that fills the buffer chamber, and designed to effect a reduction in the variable volume of the buffer chamber.

7. The apparatus as claimed in claim 4, wherein the buffer chamber comprises a moving wall, said moving wall having one face facing toward the buffer chamber and an opposite face facing toward a control chamber, and wherein said apparatus comprises a means of pressurizing the control chamber.

8. The apparatus as claimed in claim 1, wherein the means capable of emitting a leak signal is able to trigger the shutting-off of the supply of gas to the distribution system.

9. A method for detecting a gas leak in a gas distribution system or part thereof, connecting a gas source or supply to at least one gas-consuming peripheral, or for determining normal or abnormal operation of this distribution system or part thereof, using an apparatus as claimed in claim 1, and wherein:
(a) the gas flow rate is measured at the inlet when the valve is in the closed position,
(b) the measured flow rate is compared against a predetermined value, and
(c) a leak signal signaling that there is a leak between the flow measurement means and the valve is emitted when the measured flow rate is higher than said predetermined value and/or a no-leak signal signifying that there is no leak is emitted when the measured flow rate is below said predetermined value.

10. The method as claimed in claim 9, wherein use is made of a buffer chamber capable of containing an amount of gas corresponding at least to the average amount of gas used over a period of time corresponding at least to once and preferably at least to twice the time needed, with no gas consumed in said distribution system or part thereof downstream of the device, to fill the buffer chamber with an amount of gas equal to or greater than said second predetermined value.

11. The method as claimed in claim 9, wherein use is made of a buffer chamber positioned in parallel with a pipe associated with the distribution system or part thereof or peripheral, the buffer chamber being positioned downstream of the distribution system, and upstream of the peripheral or part thereof.

12. The method as claimed in claim 9, wherein the buffer chamber is designed to contain an amount of gas corresponding to a consumption, over a determined period of time, and wherein the supply of gas is interrupted by the control device if, at least for a moment during this period of time, a zero or substantially zero flow of gas to the device is not detected and/or if a constant flow of gas is detected during this period of time or part of this period and/or if a variation in flow rate of under 10% by volume is not detected.

13. The method as claimed in claim 9, wherein the leak signal triggers the shutting-off of the supply of gas to the distribution system.

14. A peripheral intended to consume gas and comprising:
(a) a variable-volume buffer chamber that can be coupled to a gas distribution system, the volume of said buffer chamber being capable of varying according to the flow of gas flowing through said distribution system; and
(b) a valve controlled by a control means and capable:
(i) when the valve is in an open first position, of allowing gas to pass from the gas distribution system to the buffer chamber in order at least to fill the buffer chamber, when the amount of gas in the buffer chamber is below or equal to a first predetermined value, and
(ii) in a closed second position, interrupting said passage of gas when the amount of gas in the buffer chamber is above or equal to a second predetermined value higher than the first predetermined value.
